(19) United States
(12) Patent Application Publication
(10) Pub. No.: US 2003/0081936 A1
(43) Pub. Date: May 1, 2003

(54) Device and method for automatic disposal of radio disturbed section in PVR

(76) Inventor: Eun Sam Kim, Seoul (KR)

Correspondence Address: BIRCH STEWART KOLASCH & BIRCH, PO BOX 747, FALLS CHURCH, VA, 22040-0747, US

(21) Appl. No.: 10/265,636

(22) Filed: Oct. 8, 2002

(30) Foreign Application Priority Data
Oct. 8, 2001 (KR) P2001-61736

(51) Int. Cl. H04N 5/76

(52) U.S. Cl. 386/46; 386/95

(57) ABSTRACT

Device and method for automatic disposal of a radio disturbed section in a PVR, wherein, when transport packets (TPs) received from a broadcasting station are stored in an HDD, a storage medium, the transport packets are store together with time information (time stamp), a period between two reproduced TPs is determined as a radio disturbed section if a difference value of time information between the adjacent two reproduced TPs having the same PIDs is greater than a preset reference value in reproduction, and the two reproduced TPs are decoded while a time period of the difference value of the time information between the two reproduced TPs is skipped, whereby preventing delay of reproduction of TPs, or stopping of reproduction in the radio disturbed section. Moreover, the detection and automatic skipping of the radio disturbed section can dispense with the requirement for the user to edit (for example, fast forward, skip forward, and the like) the radio disturbed section one by one.

This application claims the benefit of the Korean Application No. P2001-61736 filed on Oct. 8, 2001, which is hereby incorporated by reference.

### BACKGROUND OF THE INVENTION

1. Field of the Invention

The present invention relates to device and method for automatic disposal of a radio disturbed section, and more particularly, to device and method for automatic disposal of a radio disturbed section in a PVR, in which a program from a broadcasting station is stored together with time information, and a radio disturbed section is determined from the time information and is disposed as required during reproduction.

2. Background of the Related Art

An information processing rate has been improving sharply as computer technologies are developed rapidly, an information transmission rate has been improving as Internet spreads quickly, and along with these, analog televisions are also replaced with digital televisions (DTV).

The DTV provides a high quality picture, and, alike a computer, has a large sized hard disc (HDD), to provide a function of temporary, or permanent storage of broadcasted programs, and reproduction therefrom, which function is called as a PVR (Personal Video Recorder) function.

Basically, the PVR has no great difference from the present VCR (Video Cassette Recorder) in view of providing a function for recording a program. However, since the PVR is based on a digital broadcasting signal, the PVR has features of the digital broadcasting, such as simultaneous recording of different programs, and individual program watching suit to own needs regardless of broadcasting time table of the broadcasting station. Moreover, different from the present analog VCR tape, as audio, and video information is recorded in digital data, the PVR assures a picture quality of no information loss, even after countless times of recording and reproduction. Furthermore, the PVR has a time shift function which permits the user simultaneous storage, and reproduction of a program the user watches at the present time. For an example, when a telephone is calling in the middle of watching a broadcasting program, a pause button on a remote controller is pressed, for storing a broadcasting stream received thereafter, and a play button is pressed after the telephone ends, for watching the broadcasting program starting from a scene after the temporarily stopped scene which is stored in the hard disk. That is, storage and reproduction is made at a fixed time interval, continuously.

Moreover, the DTV provides, not only a plurality of channels and clear pictures simply, but also a variety of features that the analog TV can not provide.

Particularly, a multimedia data may be constructed at mere video and audio, for providing a variety of forms of multimedia services through the TV. In more detail, a direction of development of the DTV technology moves from the present high picture quality and high sound quality to technologies for providing various data services, moreover, to a technology from one direction services to conversational service technology by using a bilateral channel.

Meanwhile, the rapid development of the information and communication technology comes to a stage in which a broadcasting data is received and watched on a TV at cars, trains, and ships.

However, the reception of the broadcasting data during movement may face a radio disturbed section caused by a configuration of the ground, or weather, or the like, to fail reception of the broadcasting signal, temporarily. Moreover, a portable TV, or a TV in a radio disturbed section may fail reception of the broadcasting signal temporarily depending on a direction of an antenna or a reception region of the broadcasting signal, when a broken picture together with an unpleasant sound in a case of the reception failure may give an unpleasant feeling to the watcher.

### SUMMARY OF THE INVENTION

Accordingly, the present invention is directed to device and method for automatic disposal of a radio disturbed section that substantially obviates one or more of the problems due to limitations and disadvantages of the related art.

An object of the present invention is to provide device and method for automatic disposal of a radio disturbed section, in which TP (Transport Packet) of a particular program is stored together with time information in recording, a radio disturbed section is determined from the time information during reproduction, and a required disposal is made according to a result of determination.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the device for automatic disposal of a radio disturbed section in a PVR includes a received signal processing part for detecting TPs (transport packets) of a program on a particular channel of a user's section from received broadcasting signals, a storage medium for adding time information to the TPs of the program, a reproduction signal processing part for calculating a difference value of time information of two adjacent reproduced TPs reproduced through the storage medium, comparing the difference value with a preset reference value, to determine a radio disturbance, and skipping a time period of the difference value of the time information of the two reproduced TPs if it is determined that there is the radio disturbance, in transmission of the reproduced TP, and a decoder for splitting the TPs into video TPs and audio TPs by using PID information of the TPs received from the received signal processing part or the reproduction signal processing part, decoding the video TPs and the audio TPs, respectively.

The time information added at the storage signal processing part is relative times between TPs having the same PIDs to be stored in the storage medium.

The reproduction signal processing part calculates a difference value of time information between two adjacent reproduced TPs having the same PIDs, for determining existence of radio disturbance.

If it is determined that there is no radio disturbance, the reproduction signal processing part forwards the present reproduced TP after waiting for a time period of the time information difference value of the two reproduced TPs, after the prior reproduced TP among the two reproduced TPs is forwarded.

The reference value of the reproduction signal processing part is a maximum allowable time difference between time stamps of adjacent video TPs in which users eyes can not detect an error of the reproduced video TPs displayed on a screen.

The reproduction signal processing part includes a buffer for temporary storage of a reproduced TP of a program from the storage medium, a radio disturbance determining part for determining a radio disturbed section from the time information of two adjacent TPs having the same PIDs from the buffer, and forwarding a result of determination, and an uploaded control part for skipping a time difference of the two reproduced TPs of the radio disturbed section if it is determined that there is a radio disturbance at the radio disturbance determining part, and forwarding the present reproduced TP after waiting for a time period of the time information difference value from a right prior TP if it is determined that there is no radio disturbance.

In another aspect of the present invention, there is provided a method for automatic disposal of a radio disturbed section in a PVR for detecting transport packets (TPs) of a program of a specific channel selected by a user from received broadcasting signals for presenting to display, or recording on a storage medium, including the steps of (a) adding time information to the TPs of the program, and storing in the storage medium, (b) calculating a difference value of time information of two adjacent reproduced TPs reproduced through the storage medium, comparing the difference value with a preset reference value, (c) determining a period between the two reproduced TPs as a radio disturbed section if it is determined that the difference value is greater than the reference value, and (d) skipping a time period of the difference value of the time information of the two reproduced TPs if it is determined that there is the radio disturbance in the step (c), and decoding the two reproduced TPs directly.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a block diagram of a DTV with a PVR function in accordance with a preferred embodiment of the present invention, schematically;

FIG. 2 illustrates a flow chart showing the step of operation for making a real time watching, or recording (inclusive of time shift) in a DTV with a PVR function of the present invention;

FIG. 3 illustrates a flow chart showing the step of operation for making reproduction including a process for determining a radio disturbed section in a DTV with a PVR function of the present invention; and

FIGS. 4A-4F illustrate timing diagrams showing the steps of demultiplexing process, and determining and disposing processes of a radio disturbed section when a plurality of programs are multiplexed in one channel.

### DETAILED DESCRIPTION OF THE PREFERRED EMBODIMENT

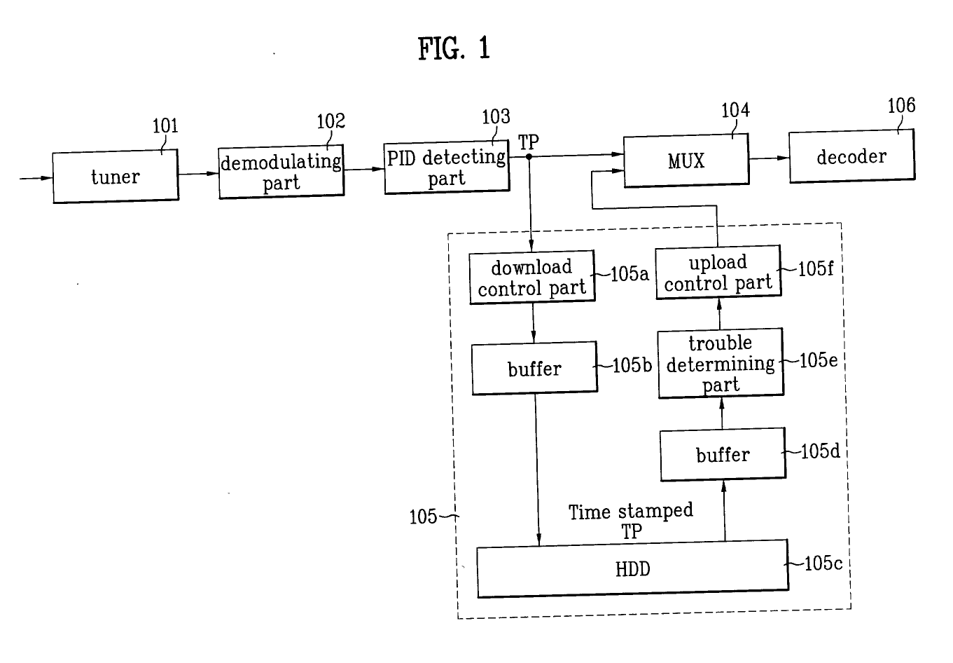

Reference will now be made in detail to the preferred embodiments of the present invention, examples of which are illustrated in the accompanying drawings. FIG. 1 illustrates a block diagram of a DTV with a PVR function in accordance with a preferred embodiment of the present invention, schematically.

Referring to FIG. 1, the DTV with a PVR function includes a tuner 101 for selecting one of channels from broadcasting stations with reference to channel information of a user's selection, a demodulating part 102 for demodulating the selected channel in a reverse process of modulation, and forwarding in forms of TPs, a PID detecting part 103 for detecting a PID (Packet Identification) from the TP, and selecting TP of a program the user desires only, a PVR part 105 for giving time information to the TP of the program detected at the PID detecting part 103, and storing in a storage medium (for an example, an HDD) for recording and making time shift, and reading the TP of the program of the user's selection from the storage medium, determining a radio disturbed section from a difference of time information of two successive TPs, and controlling forwarding of the reproduced TPs according to a result of determination in reproduction, a multiplexer 104 for selecting an output from the PID detecting part 102 when the user desires real time watch of a received broadcasting signal, and selecting an output from the PVR detecting part 105 when the user desires to watch the broadcasting program stored in the storage medium, and a decoder 106 for splitting the TP received from the multiplexer 104 into an audio TP and a video TP, and decoding respectively.

The PVR part 105 includes a download control part 105a for inserting time information to the TP from the PID detecting part 103, a buffer 105b for temporary storage of the TP having the time information added thereto at the download control part 105a, an HDD 105c for storing the TP having the time information added thereto from the buffer 105b, a buffer 105d for temporary storage of the TP of the program from the HDD 105c in reproduction, a radio disturbance determining part 105e for determining a radio disturbed section from the time information of two successive TPs from the buffer 105d, and forwarding a result of determination, and an upload control part 105f for skipping a time difference of the radio disturbed section if it is determined there is a radio disturbance at the radio disturbance determining part 105e, and forwarding the reproduced TP to the multiplexer 104 at once. The download control part 105a, the buffer 105b are called as a storage signal processing part, and the buffer 105d, the radio disturbance determining part 105e, and the upload control part 105f are called as a storage signal processing part.

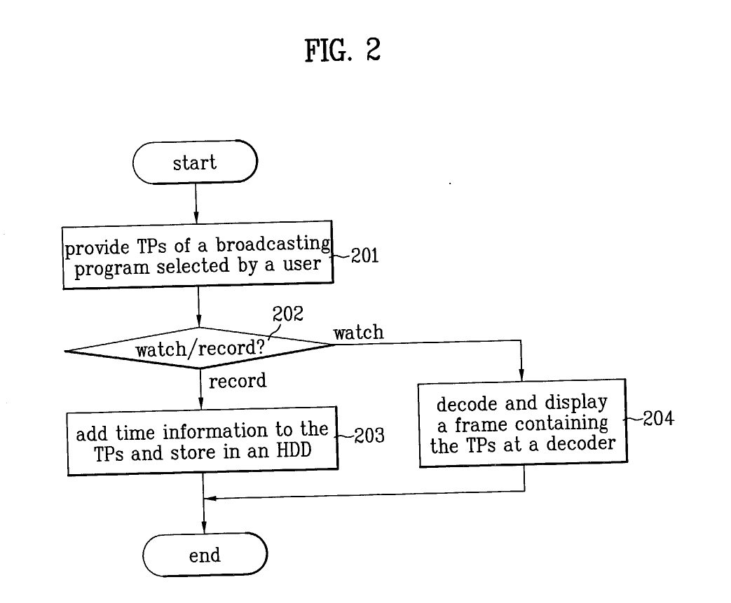

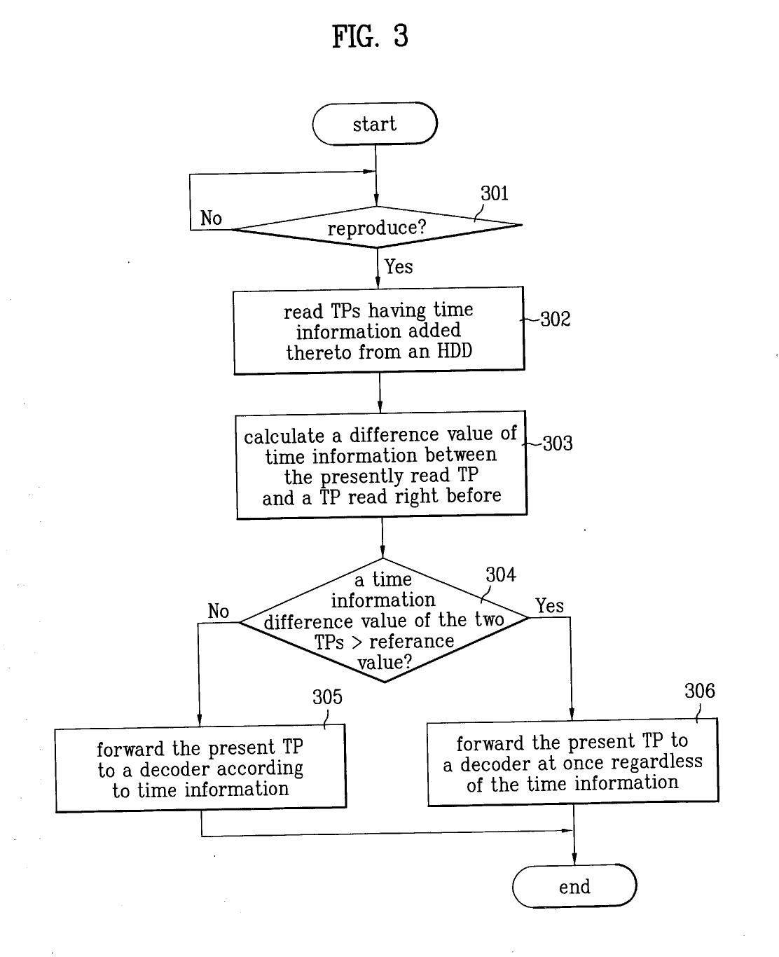

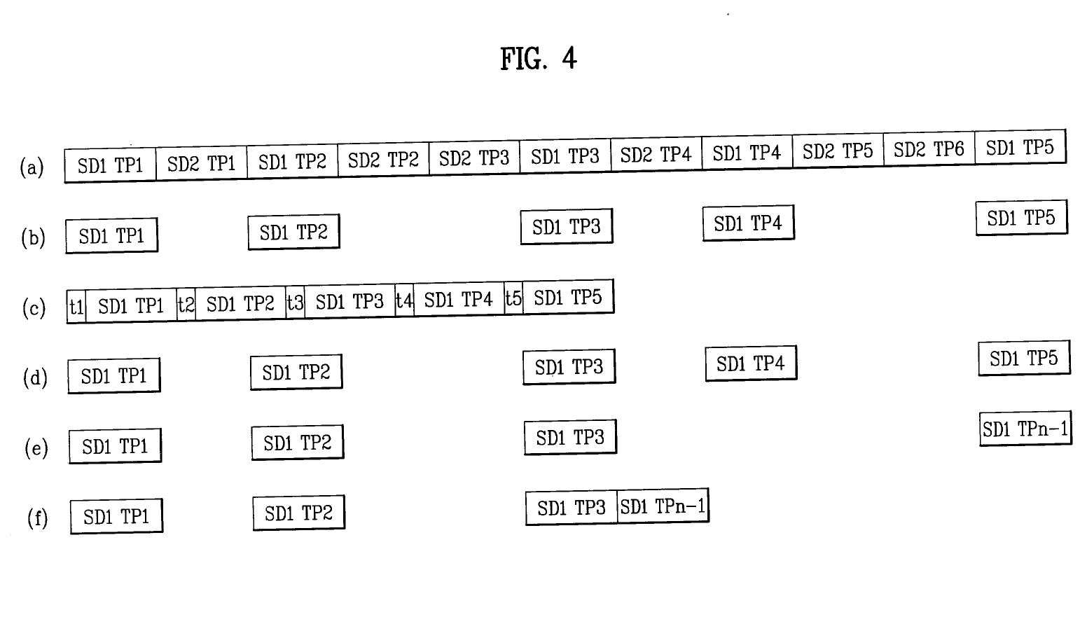

FIG. 2 illustrates a flow chart showing the step of operation for making a real time watching, or recording (inclusive of time shift) in a DTV with a PVR function of the present invention, FIG. 3 illustrates a flow chart showing the step of operation for making reproduction including a process for determining a radio disturbed section in a DTV with a PVR function of the present invention, and FIGS. 4A-4F illustrate timing diagrams showing the steps of demultiplexing process, and determining and disposing processes of a radio disturbed section when a plurality of programs are multiplexed on one channel.

A transmission side (for an example, a broadcasting station) in the present invention digitizes, and compresses various audio, video, and other program specific information, makes into one transport stream structure by means of a multiplexing devices, and forwards. The video information is compressed by MPEG-2 algorithm, and the transport stream is transmitted in packets each with 188 byte size (hereafter called as TP), and decoded in TPs at a reception side.

That is, the MPEG-2 transport stream has packets each with a fixed length of 188 bytes consisting of a four bytes of packet header and a 184 bytes of payload. The first byte of the packet header is a synchronization byte, with the same value of 0×47 for all packets. The packet header part also has a PID, representing a signal loaded on the payload. The payload has a Video Packetized Elementary Stream (video PES), an Audio PES, and Program Specific Information (PSI). That is, since the video PES, the audio PES, and the PSI have PIDs respectively, the header information of the TP may be detected for identifying the data on the payload of the TP of being the video PES, the audio PES, or the PSI PES. The PSI has various information provided from the broadcasting station for the convenience of watchers, and PID values of the video and audio on programs of the broadcasting stations.

Accordingly, referring to FIG. 1, the tuner 101 receives a plurality of channels from satellites, cables, and ground waves, selects a RF signal of a channel having the user selected from the plurality of channels, converts into an IF signal, and forwards to a demodulating part 102. The demodulating part demodulates, and digitizes the IF signal of the selected channel as a reverse process of a modulating process, and forwards to the PID detecting part 103 in a form of the transport packet TP.

The PID detecting part 103 parses PSI from the TP from the demodulating part 102, and extracts a video TP and an audio TP of the selected program (S 201). There may be a plurality of programs multiplexed in the tuned channel, when the PID is used for extracting the video TP and the audio TP of the user's desired program only.

FIGS. 4A-4F illustrate timing diagrams showing the steps of demultiplexing process, and determining and disposing processes of a radio disturbed section when a plurality of programs are multiplexed in one channel.

FIG. 4A illustrates one example two programs SD1, and SD2 are multiplexed in one channel, wherein it can be noted that, when the user selects the SD1 program, only the TP of the SD1 program is extracted as shown in FIG. 4B.

FIG. 4 illustrates an example of detection of only the video TP of the SD1 program of the convenience of explanation.

Referring to FIG. 4B, the extracted video TP is provided to the multiplexer 104 and/or the download control part 105a of the PVR part 105. When the user desires a real time watching, an output from the PID detecting part 103 is provided to the decoder 106 through the multiplexer 104, and when the user desires recording or time shift, the output of the PID detecting part 103 is provided to the PVR part 105 (S 202).

First, when the user desires a real time watching of the received broadcasting signal in the step 202, the decoder 106 splits a bit stream having the audio TP and the video TP of the SD1 program multiplexed therein into the audio TP and the video TP, subjected to decoding respectively, and present to the speaker and the TV screen (S204). Then, the user can watch to SD1 program.

In the meantime, when the user selects a recording key, or a time shifting key in the step 202, the download control part 105a of the PVR part 105 inserts time information, for an example, a time stamp, representing a received time into the video and audio TPs of the SD1 program as shown in FIG. 4C, and stores in the HDD 105c through the buffer 105b (S203). The time stamp is added to the TPs recorded on the HDD 105c for making a reproduction rate to be the same with an initial transmission rate.

The time stamp is relative time information of the TP stored in the HDD 105c, a count value counted in a download counter (not shown) in the download control part (105a). The download counter is an up counter progressively increasing according to a system clock (for an example, 27 MHz clock) operative as a reference clock of the DTV. That is, the download control part 105a inserts a count value at the moment a specific TP is introduced thereto for storage in a front part of the specific TP as shown in FIG. 4C.

For an example, if the count value when a first video TP of the user's selection program is introduced is ‘0’, the count value when a second video TP of the user's selection program is introduced is ‘1’, and the count value when a third video TP of the user's selection program is introduced is ‘3’, the time stamp t1 of the first video TP is recorded in ‘0’, the time stamp t2 of the second video TP is recorded in ‘1’, and the time stamp t3 of the third video TP is recorded in ‘3’.

In the meantime, a data transmission path when the TP stored in the HDD 105c is reverse of the foregoing storage process. That is, when the user selects reproduction of a specific program (S301), TPs of the selected program are read from the HDD 105c to the radio disturbance determining part 105e through the buffer 105d (S302). In this instance, the TP to be reproduced contains the time information, i.e., the time stamp, inserted in the recording.

The radio disturbance determining part 105e calculates a difference value of time stamps of successive two TPs having the same PID (for an example, video TPs) (S303), compares the calculated difference value and a preset reference value, and determines existence of a radio disturbance (S304).

The present invention explains determination of a radio disturbance by using a difference value of time stamp values of two successive video TPs as one preferred embodiment of the present invention. However, depending on designers, the radio disturbance may be determined by using a difference value of time stamp values of two successive audio TPs.

For an example, referring to FIG. 4C, it is assumed that a reproduction video TP t2_SD1_TP2 is received following a reproduction video TP t1+SD1_TP1 from the HDD 105c.

Then, the radio disturbance determining part 105e calculates a difference value of the time stamp t1 of a right prior reproduction TP from the stamp t2 of a right after reproduction TP.

If the time stamp difference value of the two successive video TPs is greater than a preset reference value in the step 304, it is determined that there is a radio disturbance in the reception of broadcasting, the process proceeds to the step 306, and if the time stamp difference value of the two successive video TPs is equal to, or smaller than the preset reference value in the step 304, it is determined that there is no radio disturbance in the reception of broadcasting, and the process proceeds to the step 305.

The reference value is a maximum allowable range of a time difference of time stamps of adjacent video TPs.

A reproduction process will be described in a case it is determined that there is no radio disturbance in the step 304. That is, if it is determined that there is no radio disturbance in the step 304, the upload control part 105f transmits a reproduced TP to the decoder 106 through the multiplexer 104 while maintaining an exact bit rate with reference to the time stamps of the TPs reproduced from the HDD 105c (S305).

For an example, referring to FIG. 4C, it is assumed that a reproduction video TP t2_SD1_TP2 is introduced following reception of a reproduction video TP t1+SD1_TP1 from the HDD 105c to the upload control part 105f.

Then, the upload control part 105f extracts a time stamp t1 from the initially introduced reproduction TP t1+SD1_TP1, by using this, initializes an upload counter (not shown) which counts the system clock to the time stamp t1, and forwards SD1_TP1 having the time stamp t1 removed therefrom.

The upload counter is an up counter operative by a system clock the same with the system clock used in the download counter in the download control part 105a.

Then, the upload counter 105f compares a time stamp ti to an increment of the upload counter for [ti+SD1_TPi] introduced thereto after the second one, and forwards an SD1_TPi when an upload counter value is the same with the time stamp ti. That is, after waiting as much as a time stamp difference value |ti-ti₋₁| between a right prior video TP ti₋₁+SD1_TPi₋₁ and a next video TP ti+SD1_TPi successive to the right prior TP, the next video TP ti+SD1_TPi is forwarded for decoding. Thus, the upload control part 105f can forwards the TPs at time intervals (see FIG. 4D) the same with the time intervals (see FIG. 4B) of the TPs stored in the HDD 105c. The TPs (SD1 TP1-SD1 TPn) from the upload control part 105f is provided to the decoder 106 through the multiplexer 104, and decoded at the decoder 106, for prevention of a decoding error caused by overflow, or underflow of the buffer in the decoder 106. The upload control part 105f removes the time stamp from the reproduction TP before forwarding the reproduced TP to the decoder 106. That is, the time stamp is just referred to in the reproduction.

In the meantime, a reproduction process will be described in a case it is determined that there is radio disturbance in the step 304. That is, if it is determined that there is radio disturbance in the step 304, the upload control part 105f forwards the reproduction TP to the decoder 106 through the multiplexer 104 regardless of the, time stamp of the TP reproduced from the HDD 105c, i.e., without waiting for a period of the two time stamp difference (S306).

For an example, referring to FIG. 4E, it is assumed that the time stamp difference value between a video TP SD1_TP3 and a video TP SD1_TPn−1 is greater than the preset reference value due to a radio disturbance caused between the video TP SD1_TP3 and the video TP SD1_TPn−1.

Then, referring to FIG. 4F, since the radio disturbance determining part 105e determines that there is a radio disturbance, the upload control part 105f forwards the reproduction TP SD1_TPn−1 to the decoder 106 through the multiplexer at once without waiting for a period of time as much as the time stamp difference of the reproduction TP SD1_TPn−1 and a prior TP SD1_TPn−1.

As has been explained, the present invention describes a process in which a time stamp difference value is calculated for each TP, the difference value is compared with a preset reference value, and determines a radio disturbance and disposes in one preferred embodiment of the present invention.

As another preferred embodiment of the present invention, TPs with the same PIDs received for a time period (for an example ‘1’ second) are collected, and formed into a block, and the radio disturbance may be determined in blocks by using time information added to each of the blocks, or by using time information at the TP at a starting position of the blocks.

Or, the radio disturbance may be determined in the block units by comparing a number of the TPs in adjacent blocks.

It will be apparent to those skilled in the art that various modifications and variations can be made in the device and method for automatic disposal of a radio disturbed section in a PVR of the present invention without departing from the spirit or scope of the invention. Thus, it is intended that the present invention cover the modifications and variations of this invention provided they come within the scope of the appended claims and their equivalents.

As has been explained, the device and method for automatic disposal of a radio disturbed section in a PVR can determine a radio disturbed section by calculating a difference value of time information between adjacent two TPs having the same PIDs, and comparing the difference value with a preset reference value.

In the case it is determined that there is the radio disturbance, a reproduction TP is decoded at once without waiting for a time period of the time difference of the two TPs having the radio disturbed section, for prevention of delay of TP reproduction, or prevention of stopping of the reproduction in the radio disturbed section.

The detection and automatic skipping of the radio disturbed section in the present invention dispenses with requirements for edition of the radio disturbed section (fast forward, skip forward, and the like) one by one by the user.

What is claimed is:

1. A device for automatic disposal of a radio disturbed section in a PVR comprising:
a received signal processing part for detecting TPs (transport packets) of a program on a particular channel of a user's section from received broadcasting signals;
a storage medium for adding time information to the TPs of the program;
a reproduction signal processing part for calculating a difference value of time information of two adjacent reproduced TPs reproduced through the storage medium, comparing the difference value with a preset reference value, to determine a radio disturbance, and skipping a time period of the difference value of the time information of the two reproduced TPs if it is determined that there is the radio disturbance, in transmission of the reproduced TP; and
a decoder for splitting the TPs into video TPs and audio TPs by using PID information of the TPs received from the received signal processing part or the reproduction signal processing part, decoding the video TPs and the audio TPs, respectively.

2. A device as claimed in claim 1, wherein the time information added at the storage signal processing part is relative times between TPs having the same PIDs to be stored in the storage medium.

3. A device as claimed in claim 1, wherein the storage signal processing part includes a download counter for counting a system clock, for inserting a count value at a time of introduction of the TP as the time information of the TP.

4. A device as claimed in claim 1, wherein the storage medium is an HDD.

5. A device as claimed in claim 1, wherein the reproduction signal processing part calculates a difference value of time information between two adjacent reproduced TPs having the same PIDs, for determining existence of radio disturbance.

6. A device as claimed in claim 5, wherein the reproduction signal processing part calculates a difference value of time information between adjacent prior video TP and a next video TP, for determining existence of radio disturbance.

7. A device as claimed in claim 1, wherein, if it is determined that there is no radio disturbance, the reproduction signal processing part forwards the present reproduced TP after waiting for a time period of the time information difference value of the two reproduced TPs, after the prior reproduced TP among the two reproduced TPs is forwarded.

8. A device as claimed in claim 7, wherein the reproduction signal processing part includes an upload counter for counting a system clock, for transmission of the reproduced TPs while maintaining intervals as much as the time information difference value between adjacent two reproduced TPs by using count values.

9. A device as claimed in claim 1, wherein the reference value of the reproduction signal processing part is a maximum allowable time difference between time stamps of adjacent video TPs in which users eyes can not detect an error of the reproduced video TPs displayed on a screen.

10. A device as claimed in claim 1, wherein the reproduction signal processing part removes the time information from the reproduced TP before forwarding the reproduced TP to a decoder.

11. A device as claimed in claim 1, wherein the reproduction signal processing part includes;
a buffer for temporary storage of a reproduced TP of a program from the storage medium;
a radio disturbance determining part for determining a radio disturbed section from the time information of two adjacent TPs having the same PIDs from the buffer, and forwarding a result of determination, and
an upload control part for skipping a time difference of the two reproduced TPs of the radio disturbed section if it is determined that there is a radio disturbance at the radio disturbance determining part, and forwarding the present reproduced TP after waiting for a time period of the time information difference value from a right prior TP if it is determined that there is no radio disturbance.

12. A method for automatic disposal of a radio disturbed section in a PVR for detecting transport packets (TPs) of a program of a specific channel selected by a user from received broadcasting signals for presenting to display, or recording on a storage medium, comprising the steps of:
(a) adding time information to the TPs of the program, and storing in the storage medium;
(b) calculating a difference value of time information of two adjacent reproduced TPs reproduced through the storage medium, comparing the difference value with a preset reference value;
(c) determining a period between the two reproduced TPs as a radio disturbed section if it is determined that the difference value is greater than the reference value; and
(d) skipping a time period of the difference value of the time information of the two reproduced TPs if it is determined that there is the radio disturbance in the step (c), and decoding the two reproduced TPs direct1y.

13. A method as claimed in claim 12, wherein the time information added to the TP to be recorded in the step (a) is a relative time between TPs having the same PIDs to be stored in the storage medium.

14. A method as claimed in claim 12, wherein the time information added to the TP to be recorded in the step (a) is a time stamp, wherein a system clock count value at the time the TP to be recorded is received is inserted as the time stamp of the TP.

15. A method as claimed in claim 12, wherein the step (b) is determining existence of a radio disturbance by calculating a difference value of the time information of the adjacent two reproduced TPs having the same PIDs.

16. A method as claimed in claim 12, wherein the step (b) is determining existence of radio disturbance by calculating a difference value of time information between a prior video TP and a next video TP, adjacent to each other.

17. A method as claimed in claim 12, wherein the step (d) is forwarding the present reproduced TP after waiting for a time period of the difference value of the time information between the two reproduced TPs starting from a time a prior reproduced TP among the two reproduced TP is forwarded, if it is determined that there is no radio disturbance in the step (c).

18. A method as claimed in claim 12, wherein the reference value in the step (b) is a maximum allowable time difference between time stamps of adjacent video TPs in which users eyes can not detect an error of the reproduced video TPs displayed on a screen.

19. A method as claimed in claim 12, wherein the step (b) further includes the step of collecting TPs having the same PIDs received for a preset time period into a block, and determining existence of a radio disturbance in the block units by using time information added to each block, or by using time information of TP at a starting position of the block.

20. A method as claimed in claim 19, wherein the step (b) further includes the step of comparing a number of TPs in adjacent blocks, for determining existence of radio disturbance.
